(19) United States
(12) Patent Application Publication
(10) Pub. No.: US 2006/0191188 A1
(43) Pub. Date: Aug. 31, 2006

(54) Tackle rack for fishing equipment

(76) Inventor: Mark Peiser, Indianapolis, IN (US)

Correspondence Address: DANIEL J. O'CONNER;#821, 6720 BUCKHORN DR, INDIANAPOLIS, IN, 46254, US

(21) Appl. No.: 11/065,610

(22) Filed: Feb. 25, 2005

(51) Int. Cl. A01K 97/06

(52) U.S. Cl. 43/54.1

(57) ABSTRACT

A support for fishing lures and tools used in the fishing arts. The system is known as a tackle rack. It is manufactured so that a front row of holes or apertures may receive the hook portion of a fishing lure. A back row of holes or apertures is provided for the receipt of fishing tools. The overall system and method provides quick access so that a tournament fisherman can rapidly change lures at a critical time. The tackle rack is designed to be placed on a wall of a fishing boat. Various advantageous methods of arranging fishing lures in a logical manner are described.

### BACKGROUND AND OBJECTS OF THE INVENTION

The present invention is generally related to the support arts and, in particular, to racks used in the support of fishing lures and related fishing gear.

Prior art patents have typically used organizer configurations for use within a container such as a tackle box. Such systems generally do not provide the speed of access needed by a tournament fisherman.

U.S. Pat. No. 4,033,648 issued in 1977 for a “Fishing Lure Rack” teaches the use of a display and holding rack for fishing lures. Such system is relatively expensive to manufacture and does not provide space for other equipment including fishing-related tools such as pliers, scissors and other accessories.

Accordingly, it is an object of the present invention to demonstrate a novel tackle support system wherein fishing lures can be arranged by a tournament fisherman for easy and quick access.

It is a further object of the invention to show a tackle rack which includes support means for other fishing related items such as pliers and cutting implements.

It is also an object of the invention to set forth a method of use wherein a tournament fisherman can organize and plan for a fishing tournament event by utilizing the disclosed structure.

It is a further object to show a fishing tackle rack which may be economically manufactured out of, for example, aluminum materials for widespread commercial success in the art.

It is also an objective to demonstrate a system to help experienced and beginning fishermen by providing ready access to appropriate fishing lures required.

These and other objects and advantages of the disclosed system and method will be apparent to those of skill in the art from the description which follows.

### SUMMARY OF THE INVENTION

The system is designed to be mounted to any convenient vertical wall of a fishing boat for ease of access by a fisherman.

A rear panel may include two-sided tape or other equivalent means for attachment to a boat wall.

A forward panel provides strength for the unit and support for a number of fishing lures.

A middle and horizontal panel provides specially positioned holes or apertures to accommodate:
a) a number of different fishing lures which may be organized in a logical way by a tournament fisherman and
b) at least several fishing related tools to allow a fisherman to rapidly change fishing lures depending upon the particular tournament conditions encountered.

### BRIEF DESCRIPTION OF THE DRAWING FIGURES

FIG. 1 is a top schematic view of the tackle rack as mounted to the wall of a fishing boat. The front and back rows of the design are shown.

FIG. 2 is an end schematic view of the system along lines 2-2 of FIG. 1. The vertical plate sections of the design are shown.

FIG. 3 is a front schematic view of the tackle rack and shows a possible arrangement of the fishing lures and fishing tools used in the combined system and the method of use.

FIG. 4 is a partial view of the system and shows the hook portion of a fishing lure as inserted into the smaller apertures formed in the front row.

FIG. 5 is a partial view of the tackle rack system and illustrates the use of a grommet element in combination with the larger apertures of the back row.

FIG. 6 shows methods of use in the location and grouping of different types of fishing lures.

### FULL DESCRIPTION OF THE PREFERRED EMBODIMENTS

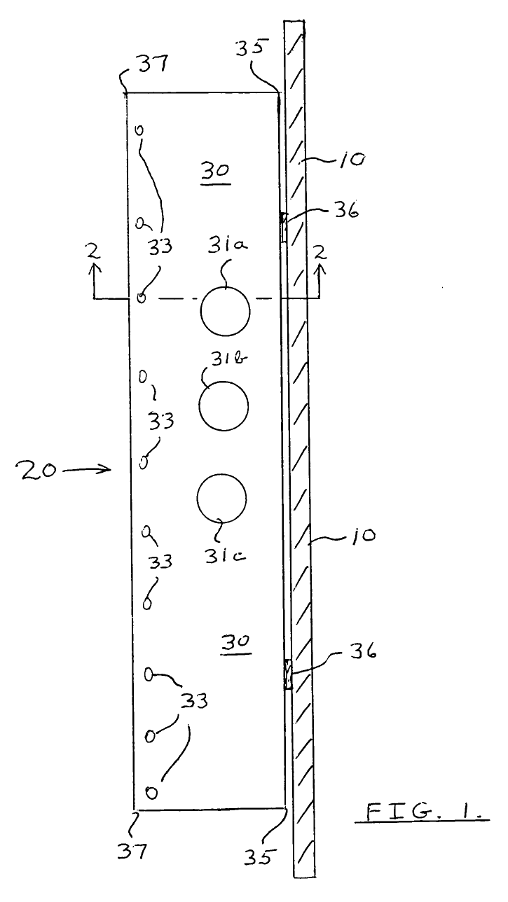

Referring to the top view drawing of FIG. 1, a tackle rack 20 is shown as mounted to a vertical wall 10 of a fishing boat by means, for example, of two-sided tape elements 36.

Numeral 30 indicates the top horizontal plate of the tackle rack. As shown, the plate 30 has a rear edge 35 and a forward edge 37.

Plate 30 includes two rows of holes or apertures. A back or rear row is comprised of plural larger apertures as indicated at numerals 31a, 31b and 31c. The purpose of the back row of apertures is for receipt of fishing tools as will be further described.

Horizontal plate 30 also includes a forward or front row of holes or apertures as indicated at numerals 33. The purpose of this front row of apertures is for receipt of the hook portion of fishing lures as will be further described.

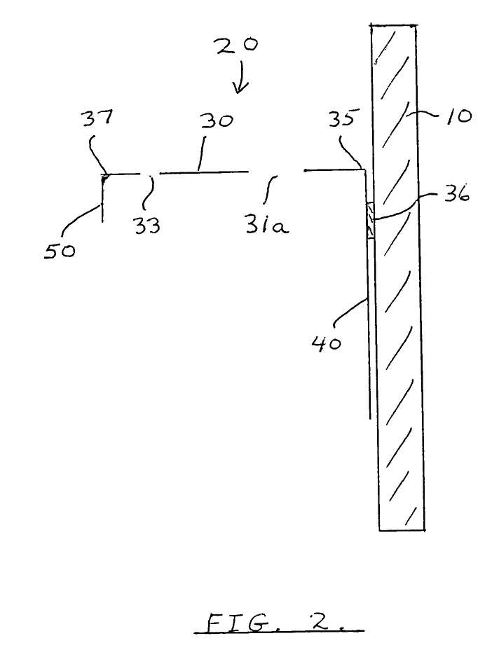

Referring to the end schematic view of FIG. 2, the tackle rack 20 is again shown as mounted to a fishing boat wall 10 via attaching means 36.

Horizontal plate 30 is shown as having a a rear edge 35 and a forward edge 37.

The back row of openings or apertures is indicated schematically at numeral 31a.

The forward row of holes or apertures is shown schematically at numeral 33.

A rear depending vertical section is shown at numeral 40. A forward depending vertical section is indicated at numeral 50.

It is to be understood that the tackle rack 20 may be fabricated of a wide variety of materials such as aluminum, plastics or other equivalent materials.

Some sample dimensions for the horizontal and vertical portions as well as for the aperture sizing will be included in this specification.

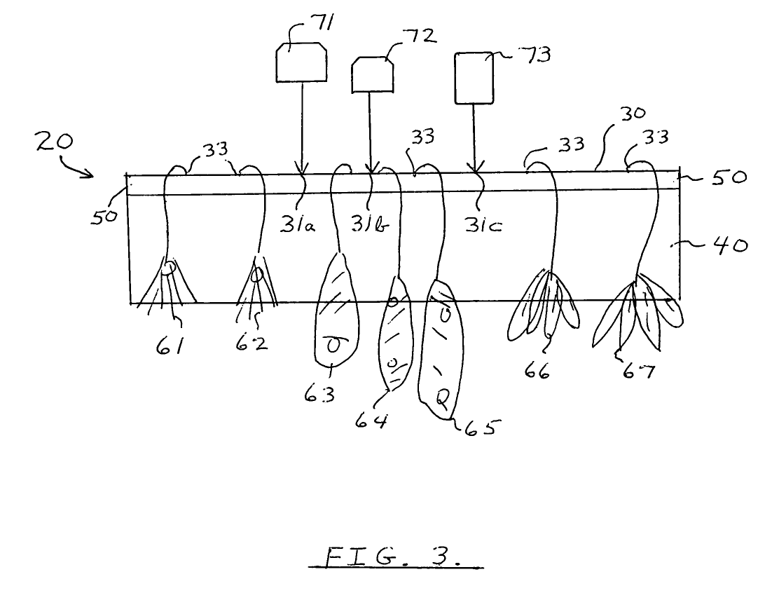

FIG. 3 shows a front schematic view of the tackle rack with lures and tool elements indicated.

The tackle rack 20 includes a front vertical section 50 and a rear vertical section 40.

Lure elements 61 through 67 are shown as having upper hook means which are placed in holes or apertures 33 on the top plate 30. Several different types of lures are indicated and are grouped as follows: Group 1 lures comprises lures 61 and 62; Group 2 comprises lures 63, 64 and 65; Group 3 comprises lures 66 and 67.

Such indicates part of the organizing method of the invention to be further described.

Tool elements 71, 72 and 73 are shown schematically as extending respectively into larger apertures or holes 31a, 31b and 31c.

The hook positions relative to the front plate 50 is to be further described.

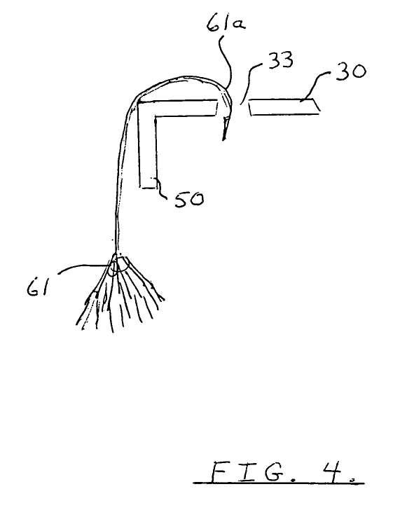

As shown in the partial view of FIG. 4, the lure 61 has an upper curved hook portion 61a which extends into aperture 33 of plate 30.

The forward vertical plate 50 thus serves as at least a partial support for the hook section to help prevent damage to same.

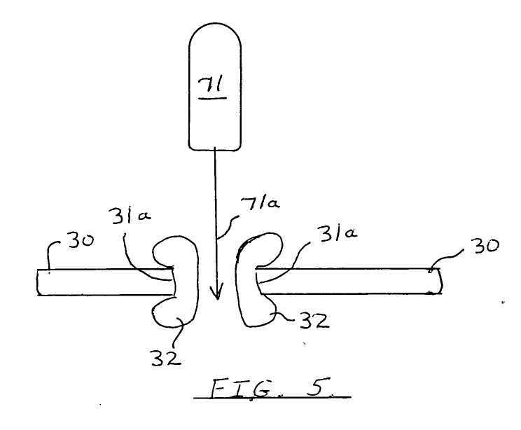

Referring to FIG. 5, this partial view shows the manner in which grommet means are used within the system. Horizontal section 30 is shown with aperture 31a formed therein. A grommet 32 is placed in aperture 31a to receive a tool element 71, the end of which extends downwardly through the grommet as indicated schematically by arrow 71a.

The tool elements 71, 72 and 73 previously referred to may comprise, for example, clipper-type cutting elements, plier-type tools, and scissor-type cutting elements.

In practice of the invention, each of the larger apertures 31a, 31b and 31c would have a grommet.

The method steps for using the structure of the invention are as follows.

In planning out a tournament day, an experienced fisherman can place the lures in the order in which they are expected to be utilized.

Alternatively, the lures can be grouped by the type of fish they are normally used for. For example, the lures could be grouped as folows:
Group 1: Catfish
Group 2: Bass
Group 3: Perch.

As a further alternative method of use, the lures could be grouped on the tackle rack according to depth of water encountered, i.e. a certain type for shallow water and other types for deeper waters.

Such grouping and planning strategies are very helpful to an experienced tournament fisherman since just a few moments can mean the difference between winning or not winning a very valuble tournament.

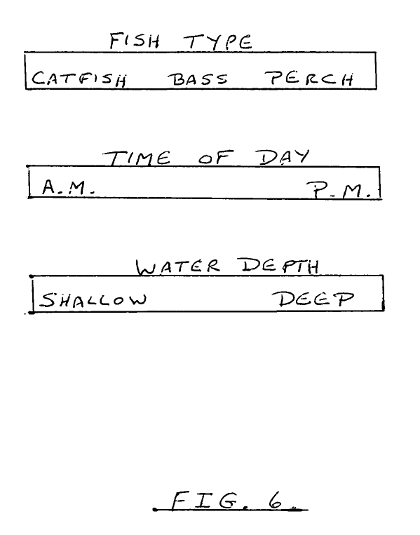

Some possible fishing lure grouping methods are indicated schematically in FIG. 6.

By utilizing these various methods and planning strategies, an experienced fisherman can get an overview of the plans for the tournament day and make adjustments or lure changes as expected conditions change.

The system and method described is also very useful for a new or beginning fisherman since he or she can have the benefit of having lures arranged in a logically progressing order by a more experienced fisherman.

While a particular system and method of use have been described, it is intended to cover all equivalent systems and methods which would reasonably occur to those of skill in the art. The invention is further defined by the claims appended hereto.

It is currently contemplated that at least three different sizes of the described tackle rack will be manufactured ranging from a smaller model of nine inches in length to a larger model of eighteen inches in length.

In accord with the current design, some important dimensions are as follows:
width of the horizontal plate is 1.75 inches,
spacing between the apertures in the front row is about 1.0 inch,
diameter of the holes in the front row is 0.125 inch,
width of the forward depending vertical section is 0.25 inch,
diameter of the apertures in the back row is 1.0 inch,

The dimensions recited, or the equivalents thereof, are deemed to be of importance since they result in a system wherein the lures and tools can be viewed and efficiently accessed to make a rapid fishing lure change as needed during a fishing tournament.

1-12. (canceled)

13. A tackle rack for supporting fishing gear including fishing lures and tools associated with fishing comprising:
an upper horizontal plate having a forward edge and a rear edge,
a first row of apertures near said forward edge for supporting a plurality of fishing lures,
a second row of apertures closer to said rear edge for supporting a plurality of fishing tools,
a rear depending vertical section for attachment to the wall of a fishing boat,
a forward depending vertical section to provide partial support for plural lures attached to the forward row of apertures,
at least one attaching element positioned on the rear depending vertical section to provide attaching means to a fishing boat,
said tackle rack further including, in combination, plurality of tool elements (71,72,73) mounted in a vertical position in the second row of apertures and comprising clipper, pliers and scissor means for use in changing lures during a fishing tournament,
wherein said second row of apertures are circular and approximately one inch in diameter and include grommet means for support of the tool elements,
wherein said first row of apertures are circular and approximately 0.125 inch in diameter and being spaced from said forward edge so that the entire diameter lies upon said upper horizontal plate,
said entire tackle rack being formed of a thin aluminum sheet and wherein said rear depending vertical section is formed at a ninety degree angle to said upper horizontal plate and wherein both are of a thickness of about 0.04 inches to provide for economical manufacture, said tackle rack being installed, in combination, in the wall of a fishing boat, said tackle rack having, in combination, a first group of fishing lures (61,62), a second different type of fishing lures (63,64,65) and a third type of lures (66,67) arranged for a fishing tourney.
